(19) United States
(12) Patent Application Publication
(10) Pub. No.: US 2016/0115289 A1
(43) Pub. Date: Apr. 28, 2016

(54) ELASTIC RIGID FOAM HAVING IMPROVED TEMPERATURE STABILITY

(71) Applicant: COVESTRO DEUTSCHLAND AG, Leverkusen (DE)

(72) Inventors: Rolf ALBACH, Köln (DE); Joern BEAUJEAN, Leverkusen (DE); Dirk LOOF, Langenfeld (DE)

(21) Appl. No.: 14/895,996

(22) PCT Filed: Jun. 3, 2014
(86) PCT No.: PCT/EP2014/061411

§ 371 Date: Dec. 4, 2015

(30) Foreign Application Priority Data
Jun. 7, 2013 (EP) 13171106.1

(51) Int. Cl. C08J 9/12; C08G 18/61; C08G 18/32; C08G 18/73

(52) U.S. Cl. CPC C08J 9/122; C08G 18/73; C08G 18/61; C08G 18/3206; C08G 18/3221; C08G 18/3225; C08J 2203/06; C08J 2379/04

(57) ABSTRACT

The invention relates to temperature-stable rigid foams which can be cold formed and have a density of 0 to 100 kg/m (according to DIN 53420), an elongation at break (according to DIN 53430) of 12 to 35%, a percentage of open cells (according to DIN ISO 4590-86) of 51% to 98% and a storage module of the foam (according to DIN EN ISO 6721 B:1996-12) in the temperature range of 60 DEG to 190 DEG C of, on average, greater or equal 0.1 MPa, and to composite materials produced with said foams.

The invention relates to cold-formable, thermally stable, rigid foams having a density of 10 to 100 kg/m³ (as determined in accordance with DIN 53420), a breaking extension (as determined in accordance with DIN 53430) of 12 to 35%, an open-cell content (as determined in accordance with DIN ISO 4590-86) of 51% to 98% and a storage modulus for the rigid polyisocyanurate foam (as determined in accordance with DIN EN ISO 6721 B:1996-12) in the temperature range from 160° to 190° C. of on average not less than 0.1 MPa, and to composite engineering materials obtained therewith.

Open-cell rigid polyisocyanurate (PIR) foams are well known as corestock plies for evacuated insulation panels. Compressive strength is what is wanted here in particular. Elasticity is undesired. U.S. Pat. No. 5,977,197 for example teaches that it is preferably open-cell polyurethane foam which should be compressed and evacuated for use as a vacuum panel. U.S. Pat. No. 5,260,344 describes open-cell PIR foams having an NCO/OH ratio of 3.5 to 13 which are obtained by using flammable and/or halogenated hydrocarbons. It transpires that specific prepolymers are needed to produce such open-cell rigid foams. U.S. Pat. No. 6,433,032 relates that the preparation of suitable prepolymers requires the use of polyalkylene oxides having ethylene oxide contents of 10 to 50 wt %. U.S. Pat. No. 5,490,224 relates that siloxane-containing polyols having 2 or more primary or secondary amino groups or hydroxyl groups are very useful for preparing open-cell PIR foams provided the siloxane group content of the mixture is not less than 10 wt %.

U.S. Pat. No. 5,312,848 describes the preparation of open-cell PIR foam laminates having an open cell content of >50% and an NCO/OH ratio of >1.5 by using aromatic polyester polyols and polyisocyanates in the manufacture of inside roof linings for automobiles. The exemplified blowing agents are chlorofluoroalkanes, the use of which is no longer allowed in Europe.

The problem addressed by the present invention was that of providing, a cold-formable, thermally stable, rigid foam having a density below 120 kg/m³ (as measured in accordance with DIN 53420) and good acoustical absorption that is still stable at above 150° C., for example in the region of an internal combustion engine.

The problem was solved by the hereinbelow more particularly described rigid polyisocyanurate (PIR) foams.

The present invention provides cold-formable, thermally stable, rigid, polyisocyanurate (PIR) foams having a density of 10 to 100 kg/m³, preferably of 10 to 50 kg/m³ (as determined in accordance with DIN 53420), a breaking extension (as determined in accordance with DIN 53430) of 12 to 35%, an open-cell content (as determined in accordance with DIN ISO 4590-86) of 51% to 98% and a storage modulus for the rigid polyisocyanurate foam (as determined in accordance with DIN EN ISO 6721 B:1996-12) in the temperature range from 160° to 190° C. of on average not less than 0.1 MPa, preferably of 0.1 to 2 MPa, characterized in that the rigid polyisocyanurate foam is the reaction product of the components consisting of
A) a polyol component A) consisting of
   a. 30 to 95 wt %, preferably 75 to 95 wt %, based on said polyol component A), of one or more polyalkylene oxides having a number average equivalent weight of 700 to 2500 g/mol, preferably 900 to 2100 g/mol, and a number average functionality of 1.8 to 2.3,
b. 0.1 to 4 wt %, based on said polyol component A), of polyalkylene oxide-modified siloxane polymers,
c. optionally NCO-reactive components from the group consisting of polyalkylene oxides other than component a., polyester polyols, polycarbonate polyols, polyamines and crosslinking agents,
d. optionally auxiliary and/or addition agents,
e. blowing agents comprising not less than 95 mol %, based on blowing agent, of carbon dioxide,
and
B) at least one isocyanate component B) from the group consisting of
   i) a mixture of
      a) 75 to 100 wt %, based on said isocyanate component B), 2,4′-diphenylmethane diisocyanate, 4,4′-diphenylmethane diisocyanate and 2,2′-diphenylmethane diisocyanate,
      b) 0 to 25 wt %, based on said isocyanate component B), of isocyanate components other than a), and
   ii) NCO prepolymers based on of a) said mixture i) and optionally b) and one or more polyether polyols having an ethylene oxide content of not more than 5 wt % and a number average functionality of 2 to 3,
      wherein the molar ratio between the isocyanate groups from said component B) and the isocyanate-reactive groups from said component A) is between 1.8:1 and 3.0:1.

The isocyanate component may thus consist of said mixture i) or of said prepolymers ii) or of a blend comprising said mixture i) and said prepolymers ii), and the latter blend is particularly preferable.

Said blowing agents e. are preferably employed in an amount of 0.1 wt % to 20 wt %, based on said polyol component A). The blowing agents comprise not less than 95 mol %, based on blowing agent, of carbon dioxide, which is preferably generated by the employment of water and/or of other substances which, on combination with isocyanate, evolve CO2.

The number average equivalent weight and the number average functionality of component a, relates to the mixture of two or more polyalkylene oxides.

Preference is also given to rigid PIR foams wherein isocyanate component B) utilizes an NCO polymer based on the mixture of a) and b) and on one or more polyether polyols provided the ethylene oxide content of the polyether polyol is not more than 5 wt % and the number average functionality is 2. Difunctional polyether polyols are employed with particular preference.

Preference is given to rigid PIR foams wherein isocyanate component B) utilizes a mixture of 4,4′-, 2,4- and 2,2′-diphenylmethane diisocyanate and their linear derivatives such as carbodiimides as component a).

The blowing agent employed under component e. may preferably come from the reaction of the isocyanate component with water and/or with carbamate.

The rigid polyisocyanurate foams of the invention are particularly useful as lightweight and stiff thermoformable corestock plies for composited engineering materials and other lightweight sandwich structures having sound-absorbing properties, more preferably inside roof linings in the automotive sector.

Component a. utilizes di- and trifunctional polyoxyalkylene polyols, optionally in admixture with tetra- to hexafunctional polyalkylene polyols, which are obtainable in a preferable manner by reaction of ethylene oxide and/or propylene oxide with di- to hexafunctional starter molecules, e.g., glycerol, trimethylolpropane, ethylene glycol, water, propylene glycols, neopentyl glycol, bisphenol A, bisphenol F, tetrabromobisphenol A, sorbitol, sugars and others.

By way of further isocyanate-reactive components c. there may be used di- to octafunctional, preferably di- to trifunctional, polyoxyalkylene polyols having an equivalent weight of 50-400 g/mol of isocyanate-reactive function, which are obtainable in a preferable manner by reaction of ethylene oxide and/or propylene oxide with starter molecules, e.g., glycerol, trimethylolpropane, propanediols, ethanediol, triethanolamine, ethylenediamine, tolylenediamine, mixtures of sugar and/or sorbitol with glycols, the monoesters of phthalic acid with glycols and others.

Suitable polyalkylene oxide-modified siloxane polymers b. are commercially available from the companies Evonik, Air Products, Momentive, Shin-Etsu and others in the marketplace. The performance fundamentals of these stabilizers are described in Silicon Chemistry, September 2006, Volume 3, pages 1-10.

Component d. may utilize the customary auxiliary and/or addition agents known per se from polyurethane chemistry, preferably from the group of catalysts, stabilizers, colorants, emulsifiers, flameproofing agents, cell openers, emulsifiers, reaction retarders, stabilizers against aging and weathering effects, plasticizers, inorganic flame retardants, modified carbon blacks, graphites and other carbons, phosphorus- and/or halogen-containing organic flameproofing agents, fungistatically and bacteriostatically active substances, pigments and dyes and also the customary organic and inorganic fillers known per se.

Useful emulsifiers include, for example, ethoxylated alkylphenols, alkali metal salts of fatty acids, betaines, alkali metal salts of sulfated fatty acids, alkali metal salts of sulfonic acids and salts of fatty acids and amines.

Catalysts include, for example, compounds that hasten the reaction of the groups containing reactive hydrogen atoms, in particular hydroxyl groups, and also of water with the isocyanates. Possibilities include organometallic compounds, preferably organotin compounds, such as tin(II) salts of organic acids of carbon, for example tin(II) acetate, tin(II) octoate, tin(II) ethylhexanoate, tin(II) laurate and the dialkyltin(IV) salts of organic acids of carbon, for example dibutyltin diacetate, dibutyltin dilaurate, dibutyltin maleate, dioctyltin diacetate, bismuth and zinc salts, and also tertiary amines such as triethylamine, tributylamine, dimethylcyclohexylamine, dimethylbenzylamine, N-methylimidazole, N-methylmorpholine, N-ethylmorpholine, N-cyclohexylmorpholine, N,N,N′,N′-tetramethylethylenediamine, N,N,N′,N′-tetramethylbutylenediamine, N,N,N′,N′-tetramethyl-1,6-hexylendiamine, pentamethyl-diethylenetriamine, tetramethyldiaminoethyl ether, bis(dimethylaminopropyl) urea, dimethylpiperazine, 1,2-dimethylimidazole, 1-azabicyclo[3.3.0]octane, 1,4-diazabicyclo[2.2.2]-octane, and alkanolamine compounds such as triethanolamine, trisisopropanolamine, N-methyldiethanolamine, N-ethyldiethanolamine, and dimethylethanolamine and also the corresponding amine oxides. Possible catalysts further include tris(dialkylamino)-s-hexahydro-triazines, specifically tris(N,N-dimethylamino)-s-hexahydrotriazine, tetraalkylammonium salts such as, for example, N,N,N-trimethyl-N-(2-hydroxypropyl) formate, N,N,N-trimethyl-N-(2-hydroxypropyl) 2-ethylhexanoate, tetraalkylammonium hydroxides such as tetramethylammonium hydroxide, alkali metal hydroxides such as sodium hydroxide, alkali metal alkoxides such as sodium methoxide and potassium isopropoxide, and also alkali or alkaline earth metal salts of carboxylic and fatty acids having 1 to 20 carbon atoms with or without pendant OH groups.

Preference is given to using isocyanate-reactive tertiary amines, for example N,N-dimethylamino-propylamine, bis(dimethylaminopropyl)amine, N,N-dimethylaminopropyl-N′-methylethanolamine, dimethylaminoethoxyethanol, bis(dimethylaminopropyl)amino-2-propanol, N,N-dimethylaminopropyldipropanolamine, N,N,N′-trimethyl-N′-hydroxyethylbisaminoethyl ether, N,N-dimethylaminopropylurea, N-(2-hydroxypropyl)imidazole, N-(2-hydroxyethyl)imidazole, N-(2-aminopropyl)imidazole, 2-((dimethylamino)ethyl)methylaminopropanol, 1,1′-(3-(dimethyl-amino)propyl)imino)bis-2 -propanol and/or the reaction products of ethyl acetoacetate, polyether polyols and 1-(dimethylamino)-3-aminopropane that are described in EP-A 0 629 607.

Useful stabilizers include, for example, organopolysiloxanes, ethoxylated fatty alcohols and alkylphenols, fatty acid-based amine oxides and betaines, and also esters of castor oil and/or ricinoleic acid.

Useful cell openers include, for example, paraffins, polybutadienes, fatty alcohols and optionally polyalkylene oxide-modified dimethylpolysiloxanes.

Polyisocyanates b) usable in isocyanate component B) are preferably aliphatic, cycloaliphatic or aromatic polyisocyanates. They are preferably room temperature liquid polyisocyanates of the diphenylmethane series. Room temperature liquid polyisocyanate mixtures of the diphenylmethane series that are obtainable in a conventional manner by phosgenation of aniline-formaldehyde condensates are very useful. Diphenylmethane-type di- and polyisocyanates modified to include urea, urethane and/or carbodiimide/uretdioneimine groups are also useful. Diphenylmethane-type di- and polyisocyanates modified to include allophanate and/or biuret groups are likewise useful.

The examples which follow illustrate the invention.

### EXAMPLES

The foams described were made by first mixing and aerating 10.7 kg of the components of the polyol mixture A as per table 1 for 10 seconds in a steel cylinder placed in a paper-lined wooden box having a volume of 1*1*1 m³. Thereafter, the isocyanate component was introduced into the cylinder as per the predetermined isocyanate index. This mixture was mixed with the same stirrer for 10 seconds. The steel cylinder was raised, and the reaction mixture spread out over the floor of the wooden box.

The “cream time” reported in the table describes the time interval between isocyanate admixture and the time at which the reaction of isocyanate with water in mixture A has progressed to such an extent that it turns creamy as a result of the CO₂ formed and visibly expands.

The “fiber time” reported in the table indicates the time interval between isocyanate admixture and the time when it is first possible to draw out fiber from the foamed material using a matchstick.

After a further two minutes, the foam was demolded and stored at room temperature for 24 hours. Then, a cube having an edge length of 0.1 m was cut out of the core of the foam to determine the apparent density. The test specimens for the measurements to DIN EN ISO 6721 B:1996-12 were cut out of the foam from directly above the central cube mentioned above. Test specimens for determining the acoustical absorption in the Kundt tube were taken from the foam at three different levels of the central region.

TABLE 1

| | Invention | Comparator | |
|---|---|---|---|
| Polyol mixture A | | | |
| propylene glycol-started polyalkylene oxide | 81.4 | 15.2 | parts by |
| (equivalent weight 2000 g/mol) | | | weight |
| glycerol-started polyalkylene oxide (equivalent | | 15.0 | |
| weight 2000 g/mol) | | | |
| phthalic anhydride/diethylene glycol-started | 10.1 | 5.0 | parts by |
| polyethylene oxide (equivalent weight 180 g/mol) | | | weight |
| polypropylene glycol (equivalent weight 110 g/mol) | | 29.4 | parts by |
| | | | weight |
| trimethylolpropane-started polypropylene glycol | | 29.7 | parts by |
| (equivalent weight 100 g/mol) | | | weight |
| water | 4.3 | 3.9 | parts by |
| | | | weight |
| Isopur Schwarzpaste N black paste (from ISL-Chemie) | 1.0 | 1.0 | parts by |
| | | | weight |
| polyether-modified polysiloxane | 0.2 | 0.2 | part by |
| | | | weight |
| potassium acetate (25 wt % in diethylene glycol) | 2.5 | | parts by |
| | | | weight |
| reaction product between 1 mol of | | 0.6 | part by |
| dimethylaminopropylamine and 2 mol of propylene | | | weight |
| oxide | | | |
| reaction product between 1 mol of | 0.5 | | part by |
| dimethylaminopropylamine and 1 mol of oleic acid | | | weight |
| OH number of polyol mixture | 74 | 363 | mg KOH/g |
| Isocyanate component B | | | |
| 2,2′-MDI | | 3 | parts by |
| | | | weight |
| 2,4′-MDI | 40.0 | 20 | parts by |
| | | | weight |
| 4,4′-MDI | 42.0 | 46 | parts by |
| | | | weight |
| higher homologs of MDI | 0 | 31 | parts by |
| | | | weight |
| carbodiimide/uretdioneimine | 2.5 | | parts by |
| | | | weight |
| polypropylene glycol (2000 g/mol) | 15.5 | | parts by |
| | | | weight |
| isocyanate index | 237 | 117 | |
| cream time | 35 | 39 | seconds |
| fiber time | 154 | 199 | seconds |
| apparent density (DIN 53420) | 39 | 32 | kg/m³ |
| breaking extension (DIN 53430) | 19% | 18% | |
| open cell content (DIN ISO 4590-86) | 94% | 78% | |
| storage modulus (DIN EN ISO 6721 B: 1996-12) at | 0.50 | 0.50 | MPa |
| 132° C. | | | |
| storage modulus (DIN EN ISO 6721 B: 1996-12) at | 0.47 | 0.08 | MPa |
| 155° C. | | | |
| storage modulus (DIN EN ISO 6721 B: 1996-12) at | 0.42 | 0.01 | MPa |
| 175° C. | | | |
| storage modulus (DIN EN ISO 6721 B: 1996-12) at | 0.32 | 0.01 | MPa |
| 200° C. | | | |
| acoustical absorption mean 315-6350 Hz | 30%-32%-31% | | |
| (DIN EN ISO 10534, bottom-middle-top) | | | |

Table 1 shows that the foam from the invention example has an advantageous open cell content for good acoustical absorbers and the good breaking extension needed for processing. Moreover, the mechanical properties are are more stable at high temperatures than with other open-cell rigid foams of comparable breaking extension.

1-2. (canceled)

3. A cold-formable, thermally stable, rigid polyisocyanurate foam having a density of 10 to 100 kg/m³, a breaking extension of 12 to 35%, an open-cell content of 51% to 98% and a storage modulus for the rigid polyisocyanurate foam in the temperature range from 160° to 190° C. of on average not less than 0.1 MPa, wherein the rigid polyisocyanurate foam is the reaction product of the components consisting of
A) a polyol component A) consisting of
a. 30 to 95 wt %, based on said polyol component A), of one or more polyalkylene oxides having a number average equivalent weight of 700 to 2500 g/mol and a number average functionality of 1.8 to 2.3,
b. 0.1 to 4 wt %, based on said polyol component A), of polyalkylene oxide-modified siloxane polymers,
c. optionally NCO-reactive components from the group consisting of polyalkylene oxides other than component a., polyester polyols, polycarbonate polyols, polyamines and crosslinking agents,
d. optionally auxiliary and/or addition agents,
e. blowing agents comprising not less than 95 mol %, based on blowing agent, of carbon dioxide,
and
C) at least one isocyanate component B) from the group consisting of
i) a mixture of
a) 75 to 100 wt %, based on said isocyanate component B), of 2,4′-diphenylmethane diisocyanate, 4,4′ -diphenylmethane diisocyanate and 2,2′-diphenylmethane diisocyanate,
b) 0 to 25 wt %, based on said isocyanate component B), of isocyanate components other than a), and
ii) NCO prepolymers based on said mixture i) and one or more polyether polyols having an ethylene oxide content of not more than 5 wt % and a number average functionality of 2 to 3, wherein the molar ratio between the isocyanate groups from said component B) and the isocyanate-reactive groups from said component A) is between 1.8:1 and 3.0:1.

4. A method comprising utilizing the rigid foam as claimed in claim 3 as lightweight and stiff thermoformable corestock plies for composited engineering materials and lightweight sandwich structures having sound-absorbing properties.

5. A composited engineering material comprising the rigid foam as claimed in claim 3.
